(19) United States
(12) Patent Application Publication
(10) Pub. No.: US 2015/0091845 A1
(43) Pub. Date: Apr. 2, 2015

(54) CAPACITANCE SENSING DEVICE

(71) Applicant: SAMSUNG ELECTRO-MECHANICS CO., LTD., Suwon (KR)

(72) Inventor: Tah Joon PARK, Suwon (KR)

(73) Assignee: SAMSUNG ELECTRO-MECHANICS CO., LTD., Suwon (KR)

(21) Appl. No.: 14/097,977

(22) Filed: Dec. 5, 2013

(30) Foreign Application Priority Data
Sep. 30, 2013 (KR) 10-2013-0116568

(51) Int. Cl. G06F 3/044

(52) U.S. Cl. CPC G06F 3/044
USPC 345/174

(57) ABSTRACT

A capacitance sensing device includes a panel unit including first electrodes arranged in columns extending in a first direction, and second electrodes arranged in rows extending in a second direction intersecting the first direction; a driving circuit unit applying driving signals to the first electrodes arranged in the columns, wherein levels of driving signals applied to first electrodes in a part of the columns are different from levels of driving signals applied to first electrodes in the other columns; a sensing circuit unit sensing a change in capacitance from the second electrodes arranged in the rows; a variable gain controller adjusting levels of signals output from the sensing circuit unit to be same; an analog-to-digital converter (ADC) converting analog signals output from the variable gain controller into digital signals; and an operation unit detecting a touch made by a user based on an output from the ADC.

### CROSS-REFERENCE TO RELATED APPLICATION

This application claims the benefit of Korean Patent Application No. 10-2013-0116568 filed on Sep. 30, 2013, with the Korean Intellectual Property Office, the disclosure of which is incorporated herein by reference.

### BACKGROUND

The present disclosure relates to a capacitance sensing device.

A touch sensing device such as a touch screen and a touch pad is attached to a display device to provide an intuitive input method to a user, and has recently been used in various electronic devices such as a cellular phone, a personal digital assistant (PDA) and a navigation device. In particular, as the demand for smartphones has increased, touch screens have been increasingly used as a touch sensing device providing various input methods in a limited form factor.

Touch screens used in a portable device may be mainly categorized into a resistive type touch screen and a capacitive type touch screen depending how a touch input is sensed. Among these, the capacitive type touch screen has advantages of a relatively long lifespan and an ease of implementing various input methods and gestures, thus becoming increasingly prevalent. It is especially easy to implement a multi-touch interface on the capacitive type touch screen compared to the resistive type touch screen, thus being widely used in smart phones and the like.

The capacitive type touch screen includes a plurality of electrodes having a uniform pattern and the electrodes define a plurality of nodes at which a change in capacitance by a touch input is generated. The nodes deployed in a two-dimensional plane generate a change in self-capacitance or mutual-capacitance by a touch input. Coordinates of the touch input may be calculated by applying a weighted average method, or the like, to the change in capacitance generated at the nodes. In order to accurately calculate the coordinates of a touch input, a change in capacitance generated by a touch input needs to be accurately sensed. However, when electrical noise occurs in a wireless communication module, a display device, or the like, a change in capacitance may not be accurately sensed.

### RELATED ART DOCUMENTS

(Patent Document 1) Korean Patent Laid-Open Publication No. 2011-0137482
(Patent Document 2) Korean Patent Laid-Open Publication No. 2011-0133963

### SUMMARY

An aspect of the present disclosure may provide a capacitance sensing device capable of minimizing noise influence on a change in capacitance.

An aspect of the present disclosure may also provide a capacitance sensing device capable of improving SNR characteristics.

An aspect of the present disclosure may further provide a capacitance sensing device capable of applying a plurality of driving signals without increasing the size of a driving chip.

According to an aspect of the present disclosure, a capacitance sensing device may include: a panel unit including first electrodes arranged in a plurality of columns extending in a first direction, and second electrodes arranged in a plurality of rows extending in a second direction intersecting the first direction; a driving circuit unit applying a plurality of driving signals to the first electrodes arranged in the plurality of columns, wherein levels of driving signals applied to first electrodes in a part of the columns are different from levels of driving signals applied to first electrodes in the other columns; a sensing circuit unit sensing a change in capacitance from the second electrodes arranged in the plurality of rows; a variable gain controller adjusting levels of signals output from the sensing circuit unit to be the same; an analog-to-digital converter (ADC) converting analog signals output from the variable gain controller into digital signals; and an operation unit detecting a touch made by a user based on an output from the ADC.

The plurality of driving signals may be configured based on a modification of the Hadamard code in which levels of signals in a part of columns of the Hadamard Code are changed.

According to another aspect of the present disclosure, a capacitance sensing device may include: a driving circuit unit applying a plurality of driving signals to a first capacitor; a first integration circuit unit including a second capacitor charged according to a change in capacitance occurring in the first capacitor based on the driving signals to generate a first output voltage; and a second integration circuit unit including a third capacitor charged according to a change in capacitance occurring in the second capacitor to generate a second output voltage, wherein levels of driving signals in a part of a plurality of columns among the plurality of driving signals applied to the first capacitor are different from levels of driving signals in the other columns.

The capacitance sensing device may further include a variable gain controller adjusting outputs from the second integration circuit unit corresponding to the plurality of driving signals to be the same.

The plurality of driving signals may be configured based on a modification of the Hadamard code in which levels of signals in a part of columns of the Hadamard code are changed.

According to another aspect of the present disclosure, a capacitance sensing device may include: a driving circuit unit applying a plurality of driving signals to a first capacitor; a first integration circuit unit including a second capacitor charged according to a change in capacitance occurring in the first capacitor based on the driving signals to generate a first output voltage; and a second integration circuit unit including a third capacitor charged according to a change in capacitance occurring in the second capacitor to generate a second output voltage, wherein the driving signals are orthogonal to one another.

Each code configuring the driving signals may include an initialization period and an integration period.

The first capacitor, the second capacitor and the third capacitor may be initialized during the initialization period.

The first integration circuit unit may include: a first switch connected to a ground terminal; and a second switch connected to an input node of the first integration circuit unit, wherein the first and second switches are turned on and off periodically, and a period at which the first and second switches are turned on and off is half a period of the driving signals applied to the first capacitor.

The second integration circuit unit may include: a third switch connected to a ground terminal; and a fourth switch connected to an input node of the second integration circuit unit, wherein the third and fourth switches are turned on and off periodically, and a period at which the third and fourth switches are turned on and off is equal to a period of the driving signals applied to the first capacitor.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of an electronic apparatus including a touch screen device according to an exemplary embodiment of the present disclosure;

FIG. 2 is a block diagram of a capacitance sensing device according to an exemplary embodiment of the present disclosure;

FIG. 3 is a circuit diagram of a capacitance sensing device according to an exemplary embodiment of the present disclosure;

FIG. 4 is a diagram illustrating the operation of the capacitance sensing device according to an exemplary embodiment of the present disclosure;

FIG. 5 is a view showing a touch screen device including a capacitance sensing device according to an exemplary embodiment of the present disclosure;

FIG. 6 is a view showing a touch screen device including a capacitance sensing device according to another exemplary embodiment of the present disclosure;

FIG. 7 is a diagram of an example of a coded driving signal;

FIG. 8 is a diagram of another example of a coded driving signal;

FIG. 9 is a diagram illustrating a plurality of driving signals according to an exemplary embodiment of the present disclosure;

FIG. 10 is a circuit diagram of a capacitance sensing device according to an exemplary embodiment of the present disclosure;

FIG. 11 is a diagram illustrating the specific operations when a capacitance sensing device is driven according to code “1” shown in FIG. 7;

FIG. 12 is a diagram illustrating the specific operations when a capacitance sensing device is driven according to code “0” shown in FIG. 7;

FIG. 13 is a diagram of a capacitance sensing device using orthogonal codes according to an exemplary embodiment of the present disclosure;

FIG. 14 is a diagram illustrating a Hadamard code which is an example of orthogonalized driving signals;

FIG. 15 is a diagram illustrating variations in output from a first integrator in a sequential driving method;

FIG. 16A and FIG. 16B are diagrams illustrating variations in output from a first integrator when the Hadamard Code illustrated in FIG. 14 is used;

FIG. 17 is a diagram illustrating orthogonalized driving signals according to an exemplary embodiment of the present disclosure;

FIG. 18 is a diagram illustrating variations in output from the first integrator when the orthogonalized driving signals according to an exemplary embodiment of the present disclosure are used;

FIG. 19 is a circuit diagram of a capacitance sensing device according to an exemplary embodiment of the present disclosure;

FIG. 20 is a diagram illustrating an ADC input when a variable gain controller according to an exemplary embodiment of the present disclosure is applied;

FIG. 21 is a diagram illustrating orthogonalized driving signals according to an exemplary embodiment of the present disclosure; and

FIG. 22 is a diagram of a capacitance sensing device according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

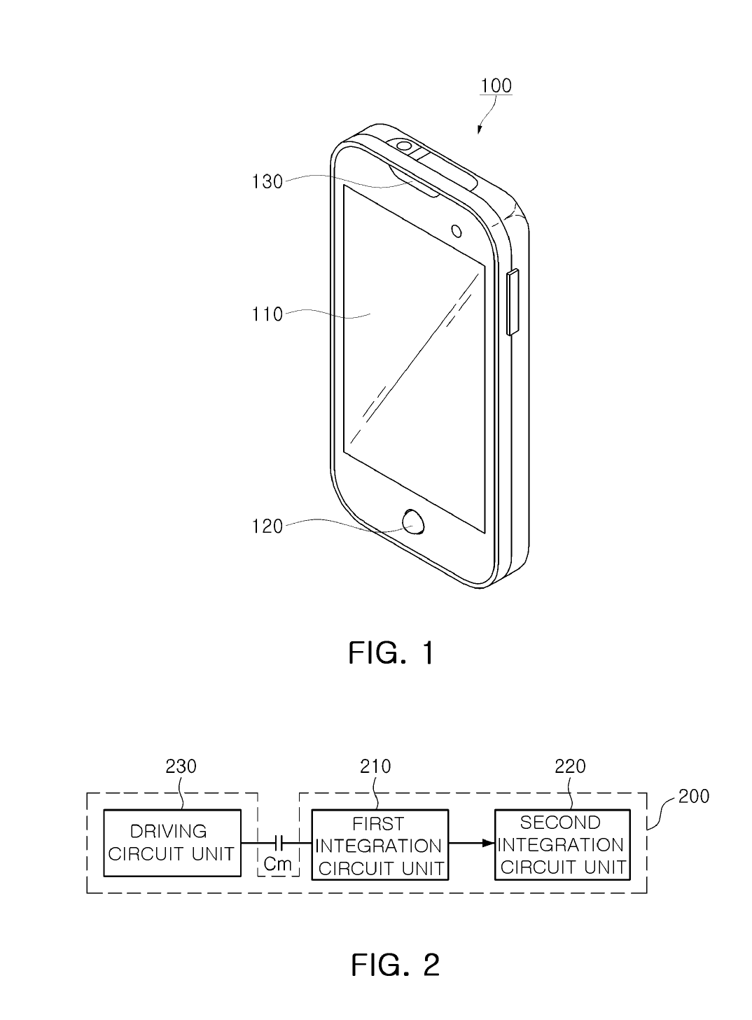

FIG. 1 is a perspective view of an electronic apparatus including a touch screen device according to an exemplary embodiment of the present disclosure. Referring to FIG. 1, the electronic apparatus 100 according to the exemplary embodiment may include a display device 110 for outputting a screen, an input unit 120, an audio unit 130 for outputting sound, and a touch screen device integrated with the display device 110.

As shown in FIG. 1, it is common in mobile devices that a touch screen device is integrated with a display device, and the touch screen device needs to have a high light transmittance such that a screen displayed on the display device can be seen. Therefore, the touch screen device may be implemented by forming a sensing electrode with a transparent and electrically conductive material such as indium tin oxide (ITO), indium zinc oxide (IZO), zinc oxide (ZnO), carbon nano tube (CNT), or graphene on a base substrate formed of a transparent film material such as polyethylene terephthalate (PET), polycarbonate (PC), polyethersulfone (PES), polyimide (PI), or the like. The display device may include a wiring pattern, connected to the sensing electrode formed of the transparent and conductive material, disposed at a bezel region thereof. Since the wiring pattern is hidden by the bezel region, it may be formed of a metal material such as silver (Ag) or copper (Cu).

Since the touch screen device according to the exemplary embodiment is a capacitive type touch screen, it may include a plurality of electrodes having a predetermined pattern. In addition, the touch screen device according to the present embodiment may include a capacitance sensing device for detecting a change in capacitance generated in the plurality of electrodes. Hereafter, a capacitance sensing device and a method of operating the capacitance sensing device according to an exemplary embodiment of the present disclosure will be described with reference to FIGS. 2 through 22.

FIG. 2 is a block diagram of a capacitance sensing device according to the exemplary embodiment of the present disclosure. Referring to FIG. 2, a capacitance sensing device 200 according to the present embodiment may include a driving circuit unit 230, a first integration circuit unit 210, and a second integration circuit unit 220. A capacitor Cm, in which a change in capacitance to be measured occurs, may be connected between the driving circuit unit 230 and the first integration circuit unit 210.

In FIG. 2, the capacitor Cm is charged by the capacitance to be measured by the capacitance sensing device 200 according to the present embodiment. As an example, the capacitance of the capacitor Cm may correspond to a mutual capacitance generated between a plurality of electrodes included in a capacitive type touch screen. Hereinafter, for convenience of description, it is assumed that the capacitance sensing device 200 according to the exemplary embodiment senses a change in capacitance generated in the capacitive type touch screen. In this case, it may be assumed that the capacitor Cm is a node capacitor in which charges are charged or from which charges are discharged by a change in the mutual capacitance generated at the intersection point between the plurality of electrodes.

The driving circuit unit 230 may generate a predetermined driving signal for charging charges in the capacitor Cm and supply it thereto. The driving signal may be a square wave of a pulse train and have a predetermined frequency. The first integration circuit unit 210 may include at least one capacitor charged or discharged by receiving the charges charged in the capacitor Cm. The first integration circuit unit 210 may generate an output voltage based on the amount of charges charged in or discharged from the capacitor. The output voltage of the first integration circuit unit 210 may be determined by the capacitance of the capacitor Cm, the capacitance of the capacitor included in the first integration circuit unit 210, a voltage level of the driving signal, and the like.

The second integration circuit unit 220 may include at least one capacitor charged or discharged by receiving the charges charged in the capacitor included in the first integration circuit unit 210. The second integration circuit unit 220 may generate an output voltage based on the amount of charges charged in or discharged from the capacitor. Each of the first and second integration circuit units 210 and 220 may include a plurality of switches. By controlling the switching operations of the switches, operations of the first and second integration circuit units 210 and 220 may be controlled.

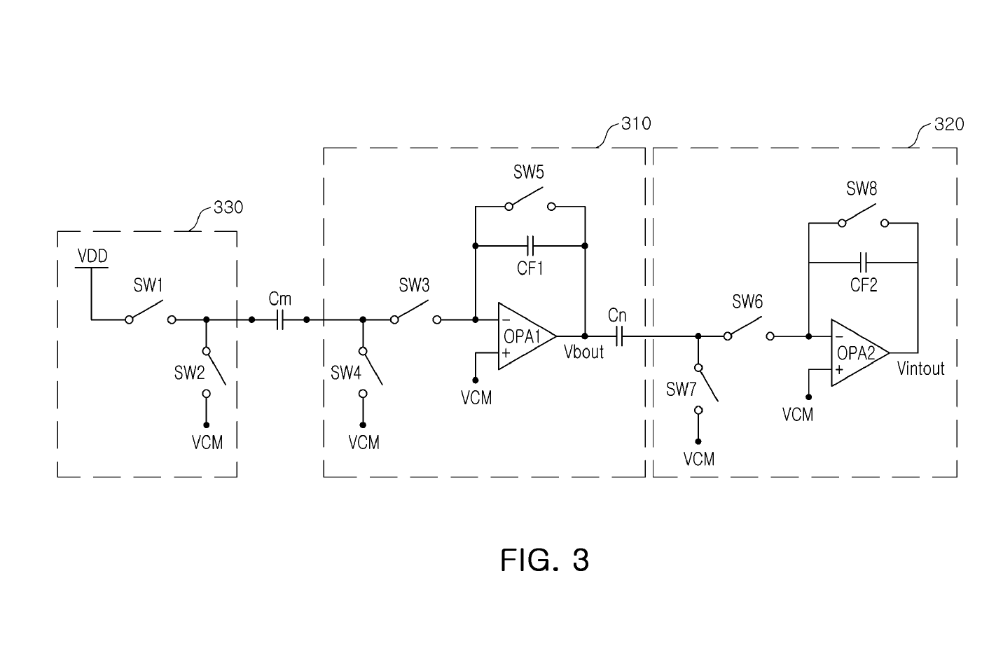

FIG. 3 is a circuit diagram of the capacitance sensing device according to the exemplary embodiment.

Referring to FIG. 3, the capacitance sensing device according to the exemplary embodiment may include a driving circuit unit 330, a first integration circuit unit 310, and a second integration circuit unit 320. Hereinafter, the operation of the capacitance sensing device according to the exemplary embodiment will be described in detail with reference to the circuit diagram shown in FIG. 3. Similar to FIG. 2, a capacitor Cm may correspond to a node capacitor of a capacitive type touch screen.

First, the driving circuit unit 330 may include two switches SW1 and SW2. The switch SW1 may be connected to a node supplying voltage VDD and a first node of the capacitor Cm. The switch SW2 may be connected a node supplying common voltage VCM and the first node of the capacitor Cm. When the switch SW1 is turned on (closed), charges may be charged in the capacitor Cm by the voltage VDD, and when the switch SW2 is turned on, the charges charged in the capacitor Cm may be discharged. As a result, the switches SW1 and SW2 may be operated at different turn-on timings.

The first integration circuit unit 310 may be connected to a second node of the capacitor Cm. The first integration circuit unit 310 may include an operational amplifier OPA1, a capacitor CF1, a capacitor Cn, a switch SW3, a switch SW4, a switch SW5, and the like. The switch SW3 may be operated two times faster than the switch SW1 of the driver circuit unit 330, and the switch SW4 may be operated two times faster than the switch SW2 of the driver circuit unit 330. That is, while the switches SW1 and SW2 are turned on and off once, the switches SW3 and SW4 may be turned on and off twice. In addition, the switches SW3 and SW4 may be operated at different turn-on timings.

The charges may be supplied to the capacitor CF1 of the first integration circuit unit 310 through the capacitor Cm by turning on and off the switches SW1 and SW3. While the switch SW5 connected in parallel to the capacitor CF1 of the first integration circuit unit 310 is turned off, the charges charged in the capacitor Cm may be delivered to the capacitor CF1, and while the switch SW 5 is turned on, the operational amplifier OPA1 may be reset. The output voltage Vbout from the operational amplifier OPA1 generated by the charges charged in the capacitor CF1 may be determined as expressed by Equation 1 below:

$$V bout = \frac{VDD * Cm}{CF 1} \qquad Equation 1$$

As can be seen from Equation 1, the output voltage Vbout from the first integration circuit unit 310 may be determined by the ratio of capacitance between the capacitor Cm and the capacitor CF1. Therefore, by configuring the capacitor CF1 to have a capacitance much larger than that of the capacitor Cm including charges to be measured, the output voltage Vbout from the first integration circuit unit 310 may not be saturated.

The second integration circuit unit 320 may be connected to a second node of the capacitor Cn included in the first integration circuit unit 310. The second integration circuit unit 320 may include an operational amplifier OPA2, a capacitor CF2, a switch SW6, a switch SW7, a switch SW8, and the like. The switch SW6 may be operated in the same period with the switch SW1 of the driving circuit unit 330, and the switch SW7 may be operated in the same period with the switch SW2 of the driving circuit unit 330. Although the switch SW6 may have the same period as that of the switch SW1, the switch SW6 may be operated as fast as the time it takes to switch on and off the switch SW3 of the first integration circuit unit 310. Likewise, the switch SW7 may have the same period as that of the switch SW2, but may be operated as fast as the time it takes to switch on and off the switch SW4 of the first integration circuit unit 310. That is, operation signals of the switches SW6 and SW7 may have the same periods with the switches SW1 and SW2, but have different phases from the switches SW1 and SW2. In addition, the switches SW6 and SW7 may be operated at different turn-on timings.

While the switch SW6 is turned on and the switches SW7 and SW8 are turned off, the charges charged in the capacitor Cn of the first integration circuit unit 310 may be delivered to the capacitor CF2, and while the switch SW8 is turned on, the operational amplifier OPA2 may be reset.

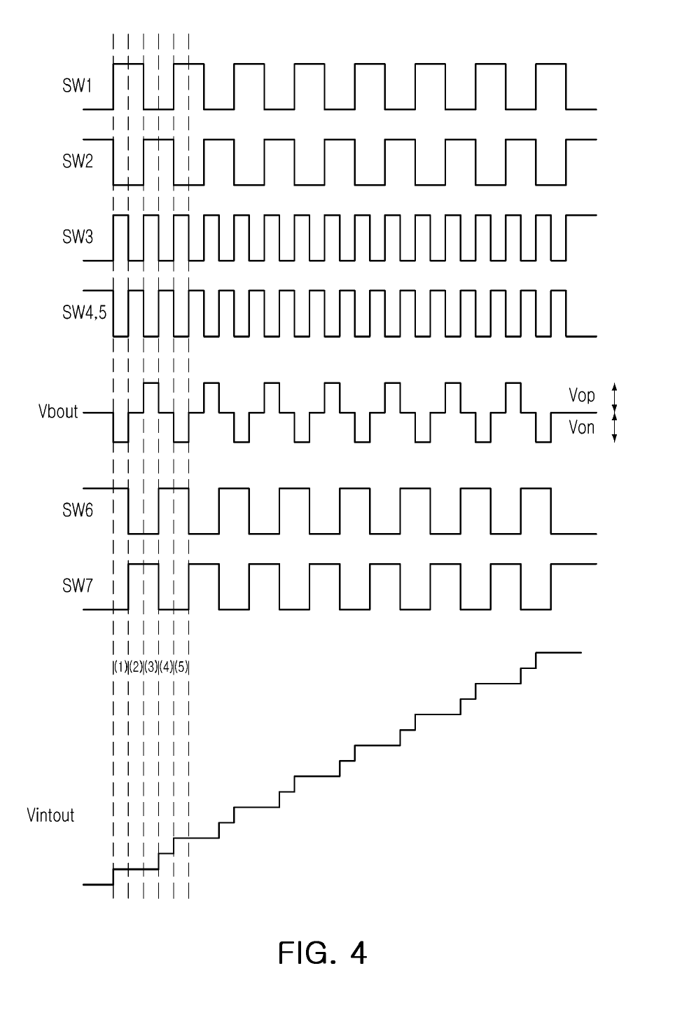

FIG. 4 is a diagram illustrating the capacitance sensing device operated as the switches SW1 to SW7 are switched on and off. In the drawing, switches are turned on where signals of the switches are at a high level whereas switches are turned off where signals of the switches are at a low level. In FIG. 4, Vbout refers to an output voltage from the operational amplifier OPA1 of the first integration circuit unit, and Vintout refers to an output voltage of the operational amplifier OPA2 of the second integration circuit unit.

In section (1), the switches SW1 and SW3 are turned on and the switches SW2 and SW4 are turned off, such that charges charged in the capacitor Cm of the first integration circuit unit by the amount of (VDD-VCM) are output after being non-inverted and integrated. In section (1), the output voltage Vbout1 output from the operational amplifier OPA1 of the first integration circuit unit is determined as expressed by Equation 2 below:

$$V bout 1 = VCM - \frac{Cm}{CF 1} * ( VDD - VCM - V noise 1 ) \qquad Equation 2$$

Here, the value of the common voltage VCM is equal to VDD/2, and Vnoise1 is the magnitude of noise introduced in section (1). In this case, charges are charged in the capacitor Cn of the first integration circuit unit by the amount of (Vbout1−VCM), and the switch SW6 is turned so that charges charged in the capacitor Cn are integrated and output through the second integration circuit unit. In section (1), an output voltage difference ΔVintout1 of the second integration circuit unit may be expressed by Equation 3 below:

$$Δ Vintout 1 = \frac{Cm}{CF 1} \frac{Cn}{CF 2} * ( VDD - VCM - V noise 1 ) \qquad Equation 3$$

That is, when a switch is operated in section (1), an output voltage Vintout from the second integration circuit unit is increased by ΔVintout1.

In section (2), the switches SW1, SW4, and SW5 are turned on and the switches SW2 and SW3 are turned off. Since the switch SW5 is turned on, the operational amplifier OPA1 of the first integration circuit unit is reset, and the operational amplifier OPA1 outputs the common voltage VCM. In section (2), the switch SW6 of the second integration circuit unit is turned off and the switch SW7 of the second integration circuit unit is turned on, such that the output voltage Vintout from the second integration circuit unit is held.

In section (3), the switches SW1 and SW4 are turned off and the switches SW2 and SW3 are turned on, such that the charges charged in the capacitor Cm by the amount of (VDD-VCM) are discharged and an output voltage Vbout2 output from the operational amplifier OPA1 of the first integration circuit unit may be expressed by Equation 4 below:

$$V bout 2 = VCM + \frac{Cm}{CF 1} * ( VCM + V noise 2 ) \qquad Equation 4$$

In Equation 2, Vnoise2 denotes noise introduced in section (3).

In section (3), the switch SW6 is turned off and the switch SW7 is turned on, such that the output voltage Vintout from the second integration circuit unit is held.

In section (4), the switches SW1 and SW3 are turned off and the switches SW2, SW4, and SW5 are turned on. Since the switch SW5 is turned on, the operational amplifier OPA1 of the first integration circuit unit is reset, and the operational amplifier OPA1 outputs the common voltage VCM. In this case, the switch SW6 is turned on and the switch SW7 is turned off, such that the charges charged in the capacitor Cn of the first integration circuit unit by the amount of (Vbout2-VCM) are discharged and an output voltage difference ΔVintout2 of the second integration circuit unit may be expressed by Equation 5 below:

$$Δ Vintout 2 = \frac{Cm}{CF 1} \frac{Cn}{CF 2} * ( VCM + V noise 2 ) \qquad Equation 5$$

Accordingly, in section (4), an output voltage Vintout from the second integration circuit unit is increased by ΔVintout2.

During one period in which the switches SW1 and SW2 are operated once, an entire output voltage difference ΔVintout of the second integration circuit unit may be expressed by Equation 6 below:

$$\begin{matrix}Δ Vintout = Δ Vintout 1 + Δ Vintout 2 \\ = \frac{Cm}{CF 1} \frac{Cn}{CF 2} ( VDD - VCM - V noise 1 ) + \\ \frac{Cm}{CF 1} \frac{Cn}{CF 2} ( VCM + V noise 2 ) \\ = \frac{Cm}{CF 1} \frac{Cn}{CF 2} * ( VDD + ( V noise 2 - V noise 1 ) )\end{matrix} \qquad Equation 6$$

Assuming that Vnoise1 is equal to Vnoise2, as seen in Equation 6, common noise may be removed in the final output of the second integration circuit unit.

During one period in which the driving signal is applied to the capacitor Cm by the switches SW1 and SW2, an effect of performing integration two times with (+) and (−) occurs, whereby the common noise may be efficiently removed.

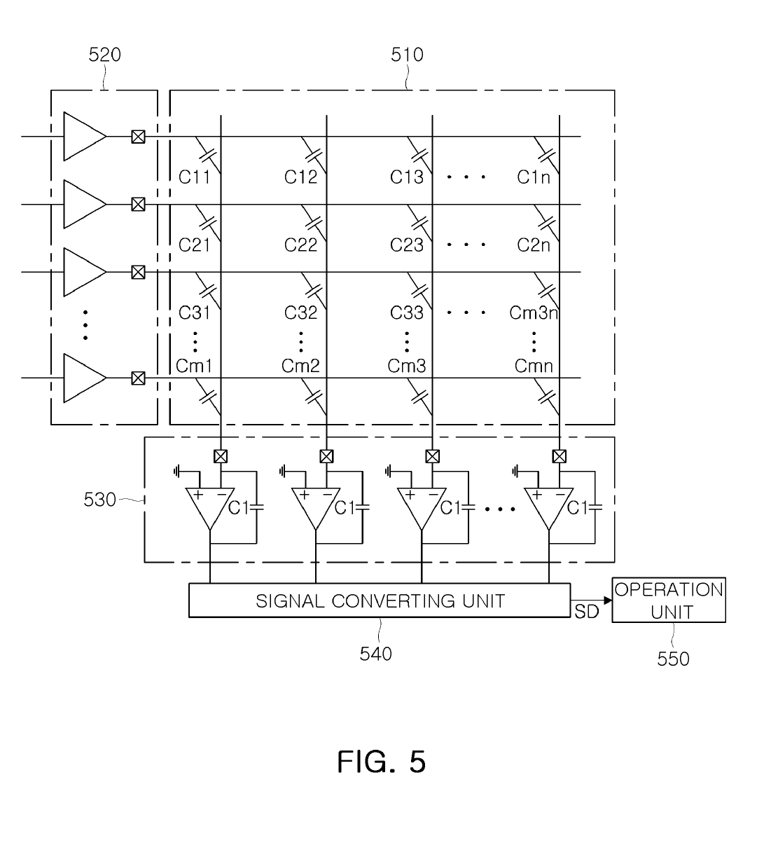

FIG. 5 is a view showing a touch screen device including the capacitance sensing device according to an exemplary embodiment of the present disclosure.

Referring to FIG. 5, the touch screen device according to the present embodiment may include a panel unit 510, a driving circuit unit 520, a sensing circuit unit 530, a signal converting unit 540, and a calculating unit 550. The panel unit 510 may include a plurality of first electrodes extended in a first axis direction, that is, a horizontal direction of FIG. 5 and a plurality of second electrodes extended in a second axis direction, that is, a vertical direction of FIG. 5, intersecting with the first axis direction, and changes in capacitance C11 to Cmn may be generated at intersection points between the first and second electrodes. The changes in capacitance C11 to Cmn generated at the intersection points between the first and second electrodes may be changes in the mutual capacitance generated by driving signals applied to the first electrodes by the driving circuit unit 520. The driving circuit unit 520, the sensing circuit unit 530, the signal converting unit 540, and the calculating unit 550 may be implemented as a single integrated circuit (IC).

The driving circuit unit 520 may apply predetermined driving signals to the first electrodes of the panel unit 510. The driving signals may be square wave signals, sine wave signals, triangle wave signals, or the like, having specific frequency and amplitude, and be sequentially applied to each of the plurality of first electrodes. Although FIG. 5 shows that circuits for generating and applying the driving signals are individually connected to the plurality of first electrodes, it is apparent that a single driving signal generating circuit may be used to apply the driving signals to the plurality of first electrodes by employing a switching circuit. Alternatively, a plurality of driving signals from a plurality of driving signal generating units may be applied to a single first electrode.

The sensing circuit unit 530 may include integration circuits for sensing the changes in capacitance C11 to Cmn from the second electrodes. Each of the integration circuits may include at least one operational amplifier and a capacitor C1 having specific capacitance. The operational amplifier has an inverting input terminal connected to the second electrode to convert the changes in capacitance C11 to Cmn into analog signals in the form of voltage, and then output the analog signals. In the case of sequentially applying driving signals to each of the plurality of first electrodes, since the changes in capacitance may be simultaneously detected from the plurality of second electrodes, the number of required integration circuits may be equal to the number m of the second electrodes.

The signal converting unit 540 may generate digital signals S_{D} from the analog signals generated by the integration circuit. For example, the signal converting unit 540 may include a time to digital converter (TDC) circuit measuring a time in which the analog signals in the form of voltage output from the sensing circuit unit 530 reach a predetermined reference voltage level to convert the measured time into the digital signal S_{D}, or an analog to digital converter (ADC) circuit measuring an amount by which a level of the analog signals output from the sensing circuit unit 530 is changed for a predetermined time period to convert the changed amount into the digital signal S_{D}. The operation unit 550 may determine whether a touch is input on the panel unit 510 using the digital signal S_{D}. As an example, the operation unit 550 may determine the number, coordinates, gesture operations, or the like, of touch inputs applied on the panel unit 510.

Comparing the capacitance sensing device shown in FIGS. 2 and 3 with the touch screen device shown in FIG. 5, the node capacitors C11 to Cmn of FIG. 5 disposed at the intersection points between the first and second electrodes may correspond to the capacitors Cm of FIGS. 2 and 3. In addition, the driving circuit unit 520 of FIG. 5 may correspond to the driving circuit units 230 and 330 of FIGS. 2 and 3, and the sensing circuit unit 530 of FIG. 5 may be an element including the first integration circuit units 210 and 310 and the second integration circuit units 220 and 320 of FIGS. 2 and 3.

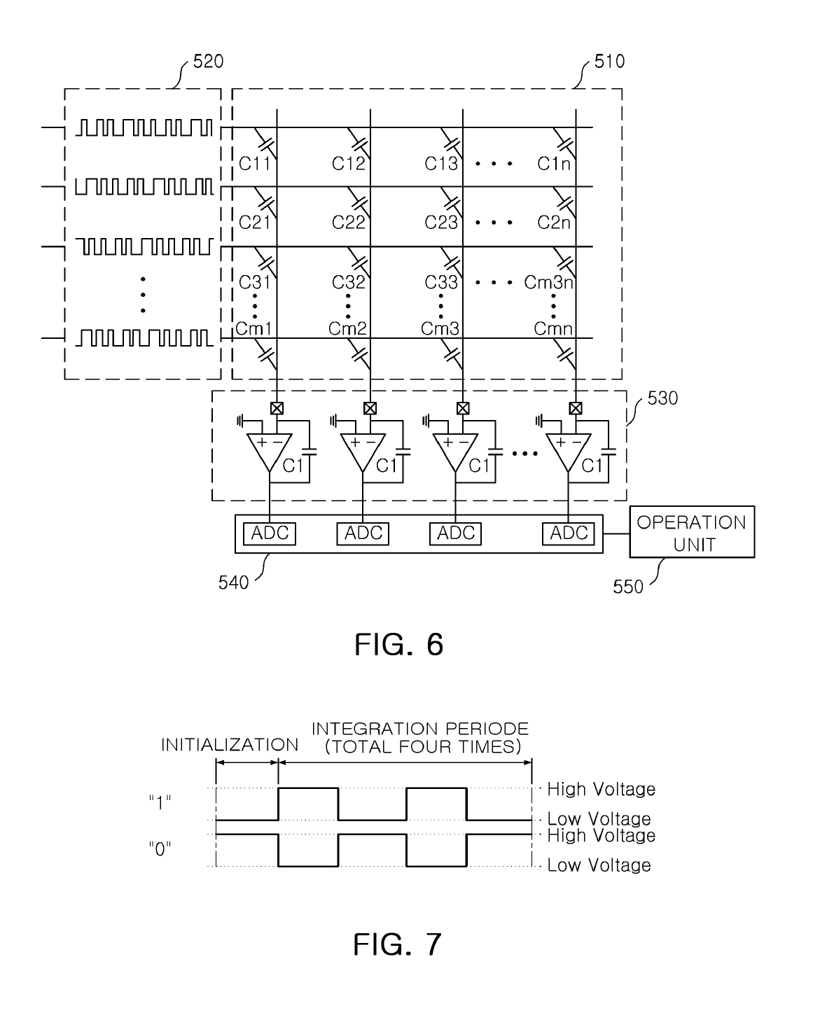

FIG. 6 is a view showing a touch screen device including the capacitance sensing device according to another exemplary embodiment of the present disclosure.

Referring to FIG. 6, the driving circuit unit 520 may simultaneously apply a plurality of coded driving signals to electrodes of the panel unit 510.

In the above-described manner, the driving circuit unit 520 sequentially applies driving signals to the electrodes of the panel unit 510. However, scanning takes a long time in this manner, and signal to noise ratio (SNR) may be deteriorated since only a small number of driving signals may be applied if a scan time is limited.

According to the exemplary embodiment, the driving circuit unit 520 may simultaneously apply a plurality of coded driving signals to electrodes of the panel unit 510 so that SNR characteristic may be improved.

In order to apply coded driving signals, a high-speed analog-to-digital converter (ADC) is necessary. According to the exemplary embodiment, however, using a differential integrator circuit may alleviate the need for the high-speed ADC. FIG. 7 is a diagram of an example of coded driving signals.

Referring to FIG. 7, the coded driving signals according to the exemplary embodiment may include initialization periods and integration periods. The integration periods may each include two pulses and a total of four integration periods may exist.

Referring to FIG. 7, an example of expressing “1” and “0” is illustrated.

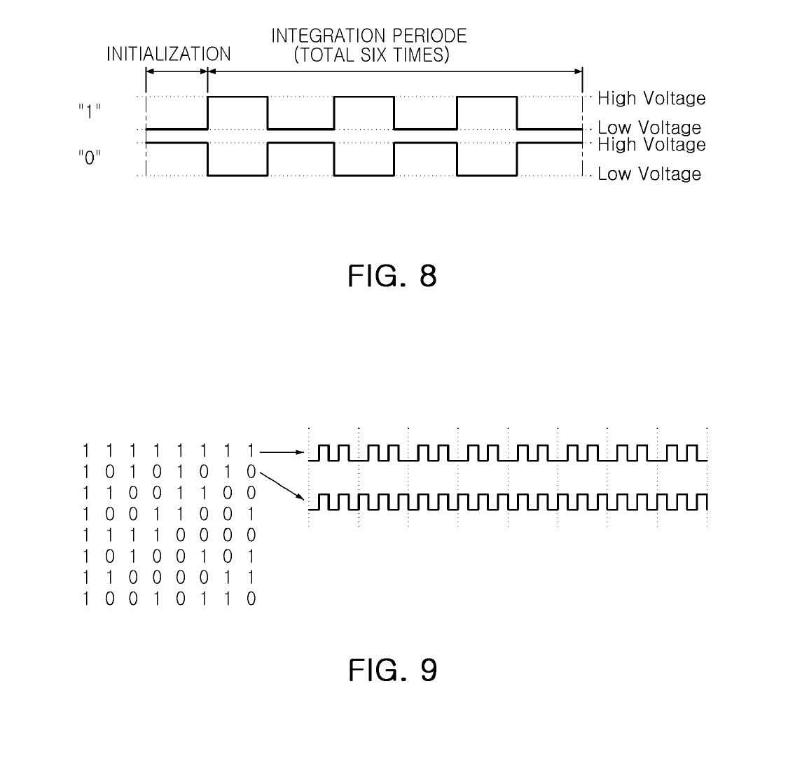

FIG. 8 is a diagram of another example of coded driving signals.

Similar to FIG. 7, the coded driving signals according to the exemplary embodiment may include initialization periods and integration periods. The integration period may each include three pulses and a total of six integration periods may exist.

Referring to FIG. 8, an example of expressing “1” and “0s” is illustrated.

The coded driving signals shown in FIGS. 7 and 8 are merely examples and those skilled in the art may consider various types of driving signals.

FIG. 9 is a diagram illustrating a plurality of driving signals according to an exemplary embodiment of the present disclosure.

As shown in FIG. 9, the driving signals applied to electrodes of the panel unit by the driving circuit unit 520 may be orthogonal to each other.

The coded driving signals shown in FIG. 9 are merely examples and those skilled in the art may consider various types of driving signals.

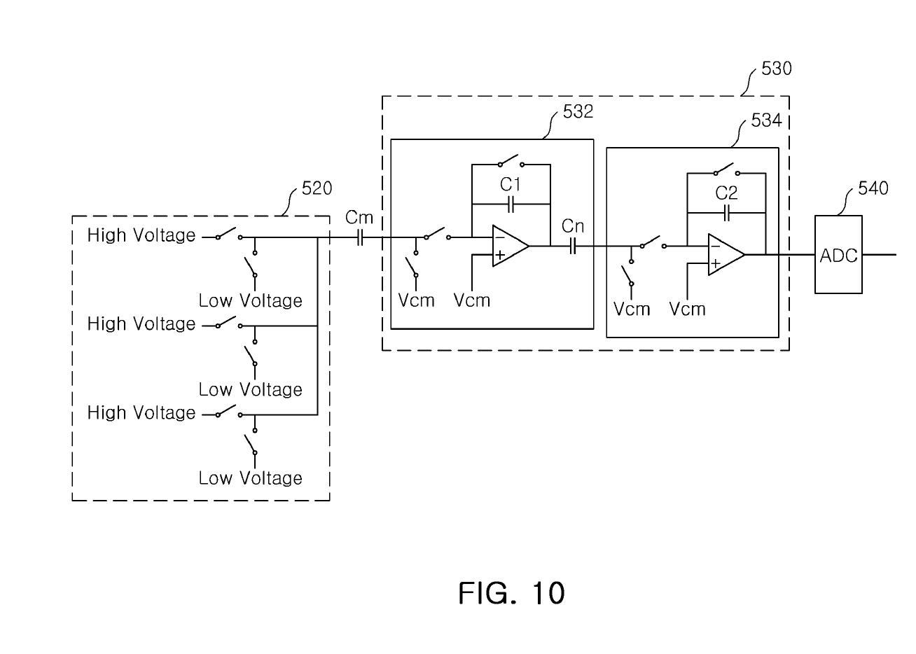

FIG. 10 is a circuit diagram of a capacitance sensing device according to an embodiment of the present disclosure.

Referring to FIG. 10, the capacitance sensing device according to the exemplary embodiment may include a driving circuit unit 520, a first integration circuit unit 532, a second integration circuit unit 534, and an ADC 540.

According to the exemplary embodiment, the driving circuit unit 520 may include a plurality of driving circuits in order to apply a plurality of driving signals.

Although the driving circuit unit 520 applies three driving signals in FIG. 10, it may apply more driving signals simultaneously.

The capacitance sensing device according to the exemplary embodiment may be driven by a plurality of driving signals orthogonal to each other.

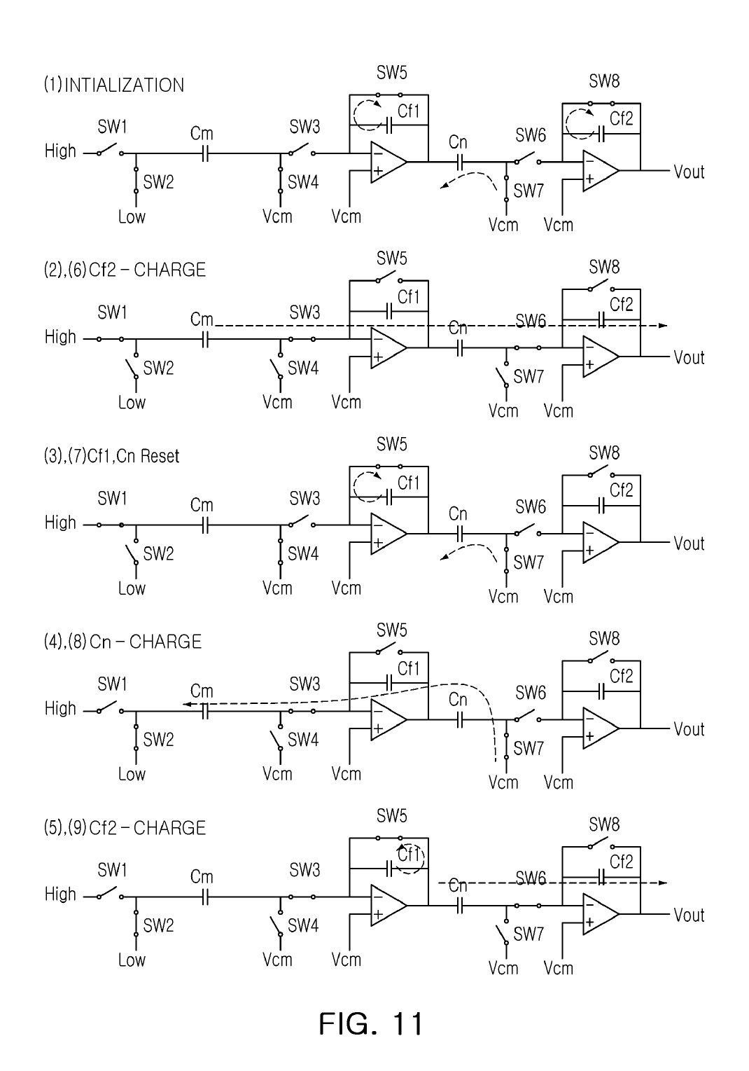

FIG. 11 is a diagram illustrating the specific operations when the capacitance sensing device is driven according to code “1” shown in FIG. 7.

According to an exemplary embodiment, an initialization operation may be performed with respect to code “1” (period (1)). Here, as shown in FIG. 11, the initialization operation may be performed when the switches SW1, SW3 and SW6 are turned off while the switches SW2, SW4, SW5, SW7 and SW8 are turned on.

The capacitor Cf2 may be charged (periods (2) and (6)). For example, when the switches SW1, SW3 and SW6 are turned on while the switches SW2, SW4, SW5, SW7 and SW8 are turned off, the capacitor Cf2 may be charged.

The capacitors Cf1 and Cn may be reset (periods (3) and (7)). For example, when the switches SW1, SW4, SW5 and SW7 are turned on while the switches SW2, SW3, SW6 and SW8 are turned off, the capacitors Cf1 and Cn may be reset.

The capacitor Cn may be charged (periods (4) and (8)). For example, when the switches SW2, SW3, and SW7 are turned on while the switches SW1, SW4, SW5, SW6, and SW8 are turned off, the capacitor Cn may be reset.

Further, the capacitor Cf2 may be charged (periods (5) and (9)). For example, when the switches SW2, SW3, SW4, SW5 and SW6 are turned on while the switches SW1, SW7, and SW8 are turned off, the capacitor Cf2 may be charged.

Then, the capacitor Cf2 may be charged, the capacitors C1 and Cn may be reset, the capacitor Cn may be charged, and the capacitor Cf2 may be charged.

In this manner, the capacitance sensing device according to the exemplary embodiment may perform charging/discharging with respect to code “1.” Here, the voltage Vout is output lower than the voltage VCM.

The operations of the switches SW2 to SW5 according to the operation of the switch SW1 in the integration periods (2) to (5) with respect to code “1” correspond to the operations of switches SW2 to SW5 according to the operation of the switch SW1 shown in FIG. 4.

Further, the operations of the switches SW6 and SW7 in the integration periods (2) to (5) correspond to the operations of switches SW6 and SW7 in the integration periods (1) to (4) shown in FIG. 4.

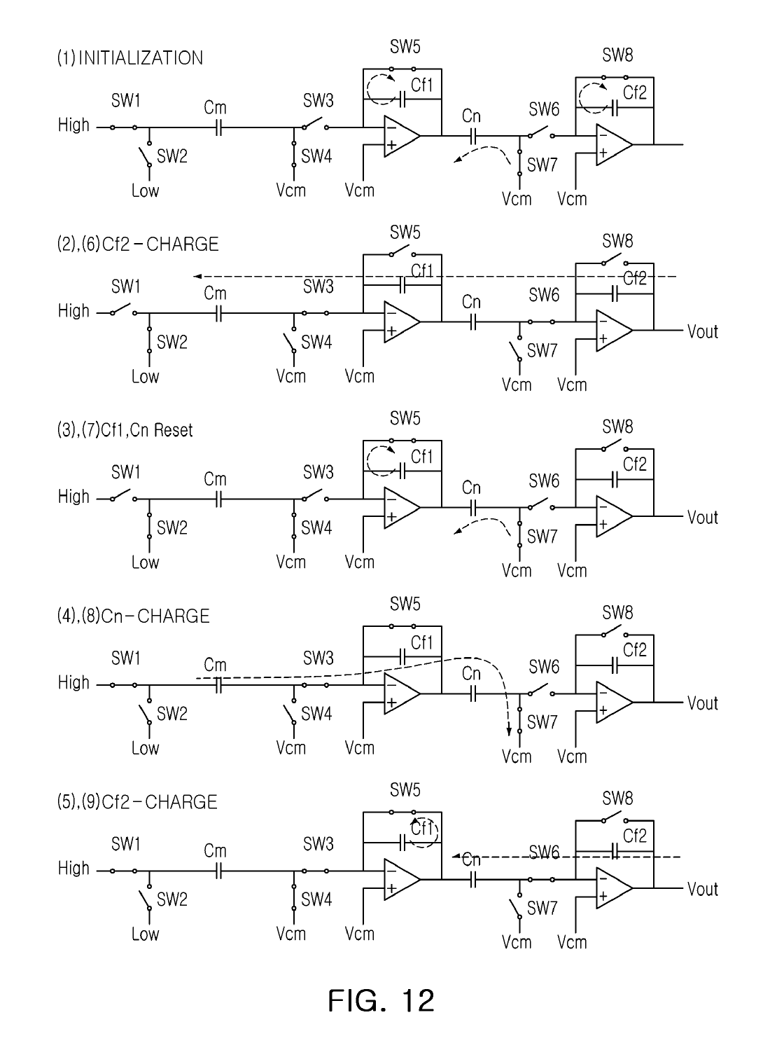

FIG. 12 is a diagram illustrating the specific operations when the capacitance sensing device is driven according to code “0” shown in FIG. 7.

According to an exemplary embodiment, an initialization operation may be performed with respect to code “0” (interval (1)). Here, as shown in FIG. 12, the initialization operation may be performed when the switches SW2, SW3 and SW6 are turned off while the switches SW1, SW4, SW5, SW7 and SW8 are turned on.

The capacitor Cf2 may be charged (periods (2) and (6)). For example, when the switches SW2, SW3 and SW6 are turned on while the switches SW1, SW4, SW5, SW7 and SW8 are turned off, the capacitor Cf2 may be charged.

The capacitors Cf1 and Cn may be reset (periods (3) and (7)). For example, when the switches SW2, SW4, SW5 and SW7 are turned on while the switches SW1, SW3, SW6, and SW8 are turned off, the capacitors Cf1 and Cn may be reset.

The capacitor Cn may be charged (periods (4) and (8)). For example, when the switches SW1, SW3, and SW7 are turned on while the switches SW2, SW4, SW5, SW6, and SW8 are turned off, the capacitor Cn may be reset.

Further, the capacitor Cf2 may be charged (periods (5) and (9)). For example, when the switches SW1, SW3, SW4, SW5 and SW6 are turned on while the switches SW2, SW7, and SW8 are turned off, the capacitor Cf2 may be charged.

Then, the capacitor Cf2 may be charged, the capacitors C1 and Cn may be reset, the capacitor Cn may be charged, and the capacitor Cf2 may be charged.

In this manner, the capacitance sensing device according to the exemplary embodiment may perform charging/discharging with respect to code “0.” Here, the voltage Vout is output lower than the voltage VCM.

The operations of the switches SW2 to SW5 according to the operation of the switch SW1 in the integration periods (2) to (5) with respect to code “0” correspond to the operations of switches SW2 to SW5 according to the operation of the switch SW1 shown in FIG. 4.

Further, the operations of the switches SW6 and SW7 in the integration periods (2) to (5) correspond to the operations of switches SW6 and SW7 in the integration periods (1) to (4) shown in FIG. 4.

In the case of FIG. 11 (code “1”), the voltage Vout may be expressed as follows:

Vout=VCM−4*(Vhigh−Vlow)*Cm*Cn/(Cf1*Cf2)

Here, Vhigh denotes a voltage at the High terminal while Vlow denotes a voltage at the Low terminal.

In the case of FIG. 12 (code “0”), the voltage Vout may be expressed as follows:

Vout=VCM+4*(Vhigh−Vlow)*Cm*Cn/(Cf1*Cf2)

When code “1” shown in FIG. 8 is used, the voltage Vout may be expressed as follows:

Vout=VCM−6*(Vhigh−Vlow)*Cm*Cn/(Cf1*Cf2)

When code “0” shown in FIG. 8 is used, the voltage Vout may be expressed as follows:

Vout=VCM+6*(Vhigh−Vlow)*Cm*Cn/(Cf1*Cf2)

According to an exemplary embodiment of the present disclosure, the voltage Vout has symmetric values with respect to the voltage VCM, such that it may be mapped with “1” and “−1” and may be used as an orthogonal code.

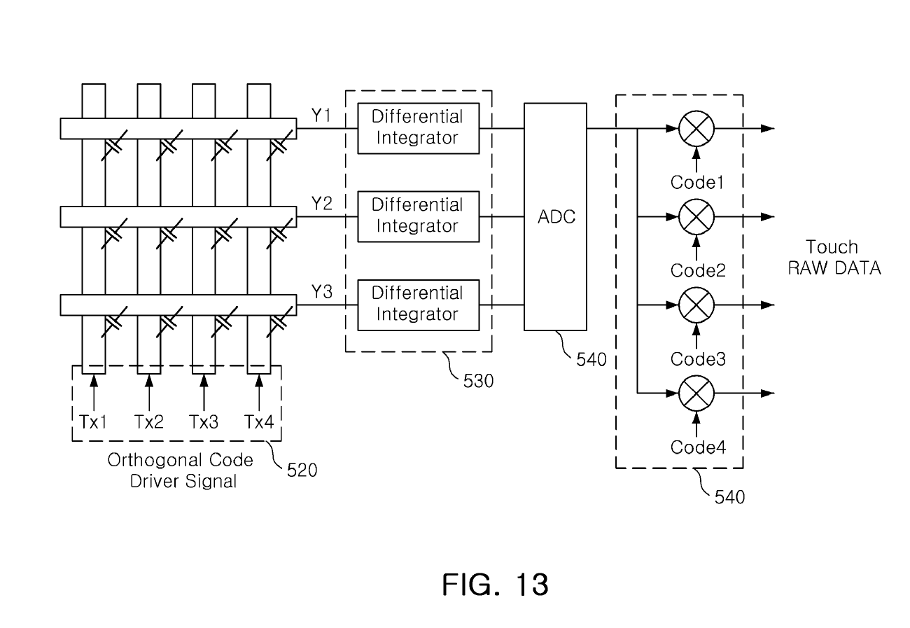

FIG. 13 is a diagram of a capacitance sensing device using orthogonal codes according to an exemplary embodiment of the present disclosure.

Referring to FIG. 13, the driving circuit unit 520 may apply a plurality of orthogonalized driving signals and the operation unit 550 may detect the orthogonal codes to determine whether there is a user's touch.

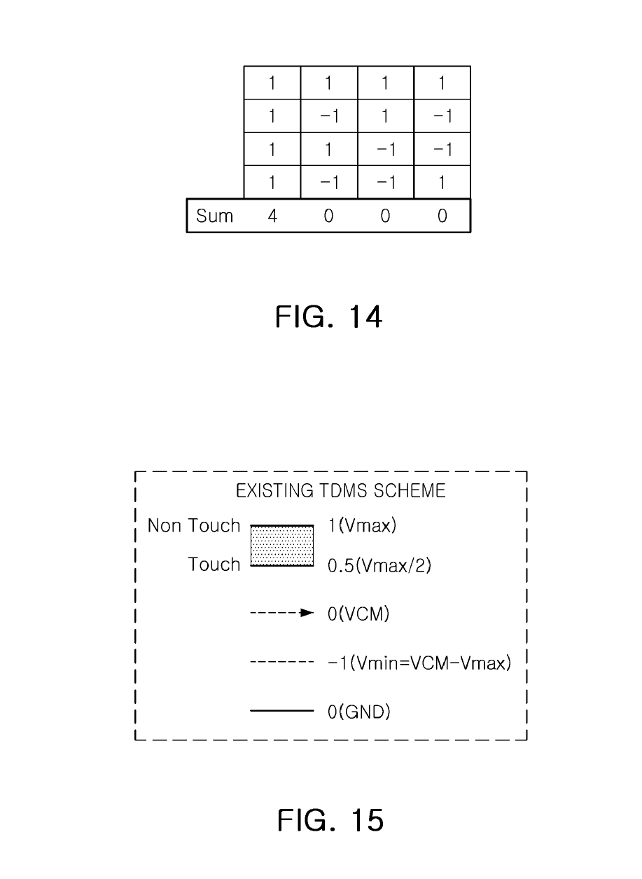

FIG. 14 is a diagram illustrating the Hadamard code, which is an example of orthogonalized driving signals.

The Hadamard code illustrated in FIG. 14 is an orthogonal signal and is commonly used.

As shown in FIG. 14, a problem may occur when the sum of values in the first column in the Hadamard code is equal to four such that a detector input becomes too large.

For convenience of description, it is assumed that the output voltage from the first integrator shown in FIG. 3 varies at most 50% depending on the presence of a user's touch. The voltage when there is no touch is Vmax while the voltage when there is a touch is Vmax/2.

FIG. 15 is a diagram illustrating variations in output from the first integrator in a sequential driving manner.

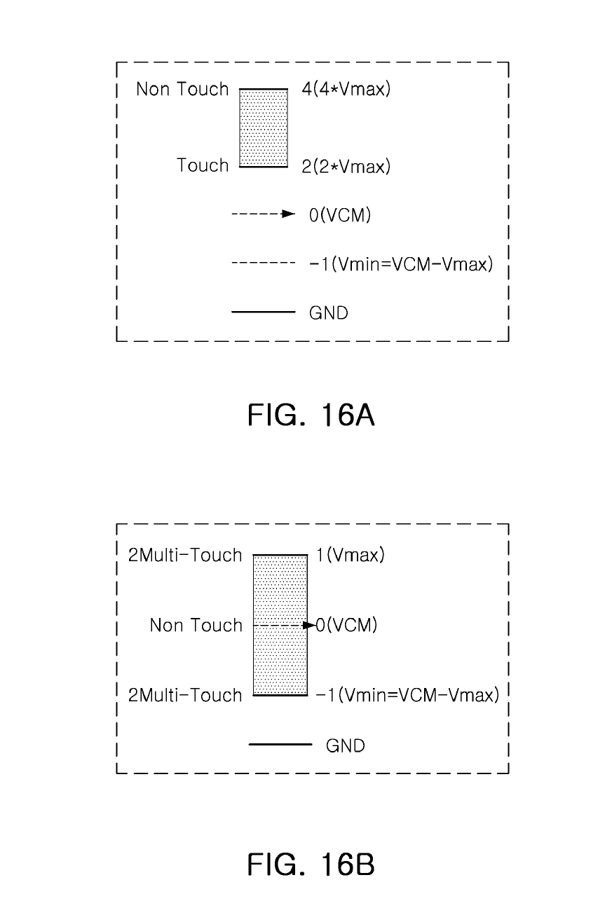

FIG. 16A and FIG. 16B are diagrams illustrating variations in output from the first integrator when the Hadamard code illustrated in FIG. 14 is used.

FIG. 16A is a diagram illustrating variations in output from the first integrator in the first column of the Hadamard Code. Here, the variations in the output are four times the variations in the output in FIG. 15.

FIG. 16B is a diagram illustrating variations in output from the first integrator in the second, third and fourth columns of the Hadamard code. Here, the peak value of the output is equal to that of FIG. 14.

Accordingly, when the Hadamard code is used, the input range of the ADC is from −1 to −4, such that it is ten times the input range (from 0.5 to 1) of the existing sequential driving manner. Therefore, when the Hadamard Code is applied with existing circuits, the first integrator and the ADC become saturated such that they may not be operated, and the capacitance of the first integrator needs to be multiplied four times and significant bits of the ADC needs to be increased. In this case, a problem occurs in that the chip size is increased.

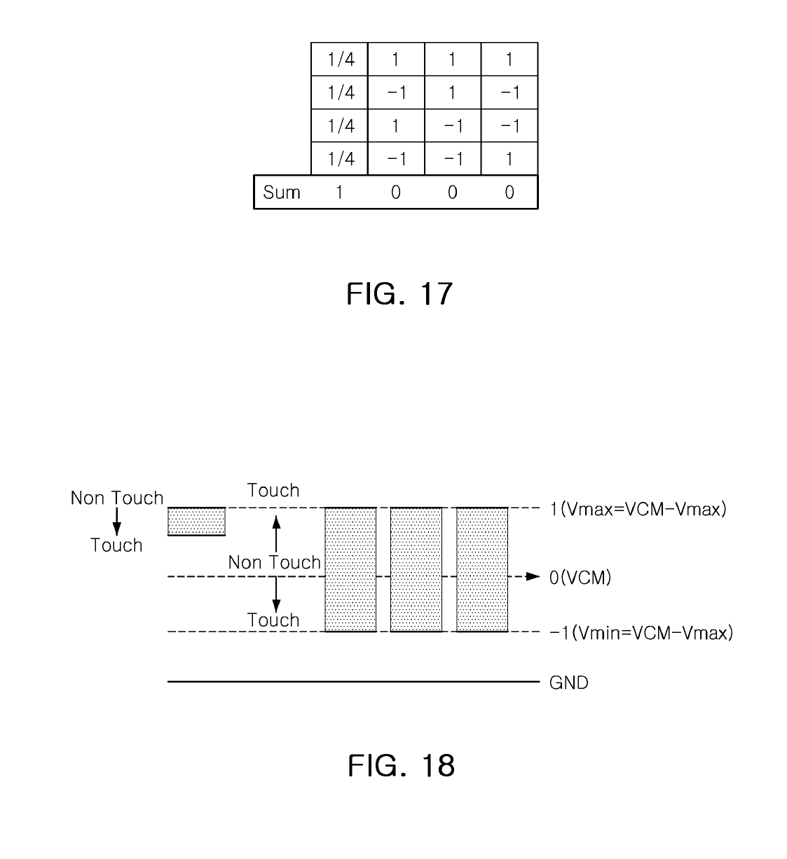

FIG. 17 is a diagram illustrating orthogonalized driving signals according to an exemplary embodiment of the present disclosure.

FIG. 17 is a diagram of a modification of the Hadamard code.

In the modification of the Hadamard code according to an exemplary embodiment of the present disclosure, the size of values in the first column is reduced to one-fourth. For example, while the value of 1 is used in the first column of the existing Hadamard code, the value of ¼ may be used in the modification of the Hadamard code according to the exemplary embodiment of the present disclosure.

As shown in FIG. 17, according to the exemplary embodiment, the sum of the values in the first column is equal to 1.

FIG. 18 is a diagram illustrating variations in output from the first integrator when the orthogonalized driving signals according to an exemplary embodiment are used.

Referring to FIG. 18, variations in output in the first column are equal to variations in output in FIG. 15. Further, variations in output in the second, third, and fourth columns are equal to those described with respect to FIG. 16B.

Accordingly, when the orthogonalized driving signals according to the exemplary embodiment are used, the first integrator is not saturated even if existing circuits are used.

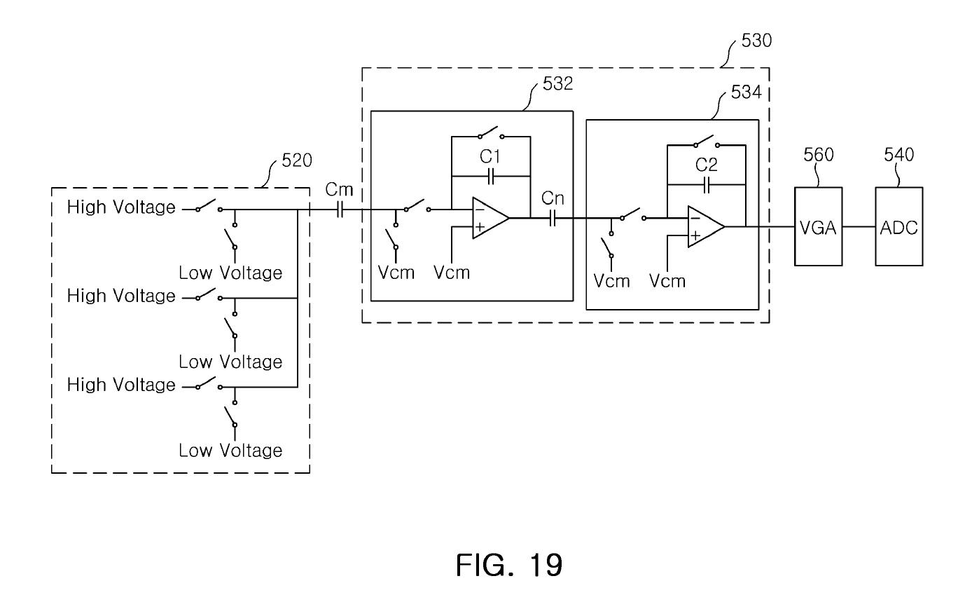

FIG. 19 is a circuit diagram of a capacitance sensing device according to an embodiment of the present disclosure.

Referring to FIG. 19, the capacitance sensing device according to the exemplary embodiment may include a driving circuit unit 520, a first integration circuit unit 532, a second integration circuit unit 534, an ADC 540, and a variable gain controller (VGA) 560.

Elements other than the variable gain controller 560 have already been described above, so only the variable gain controller 560 will be described hereinafter.

When the Hadamard code illustrated in FIG. 17 is applied, the variations in output in the first column is different from the variations in output in the second, third and fourth columns. Accordingly, it is necessary to make the variations in each column equal. By setting the input range of the ADC 540 to be identical, existing ADC 540 may be used.

The variable gain controller 560 may equalize the input range of the ADC 540 by amplifying the values in the first column by four times and maintaining the values in other columns.

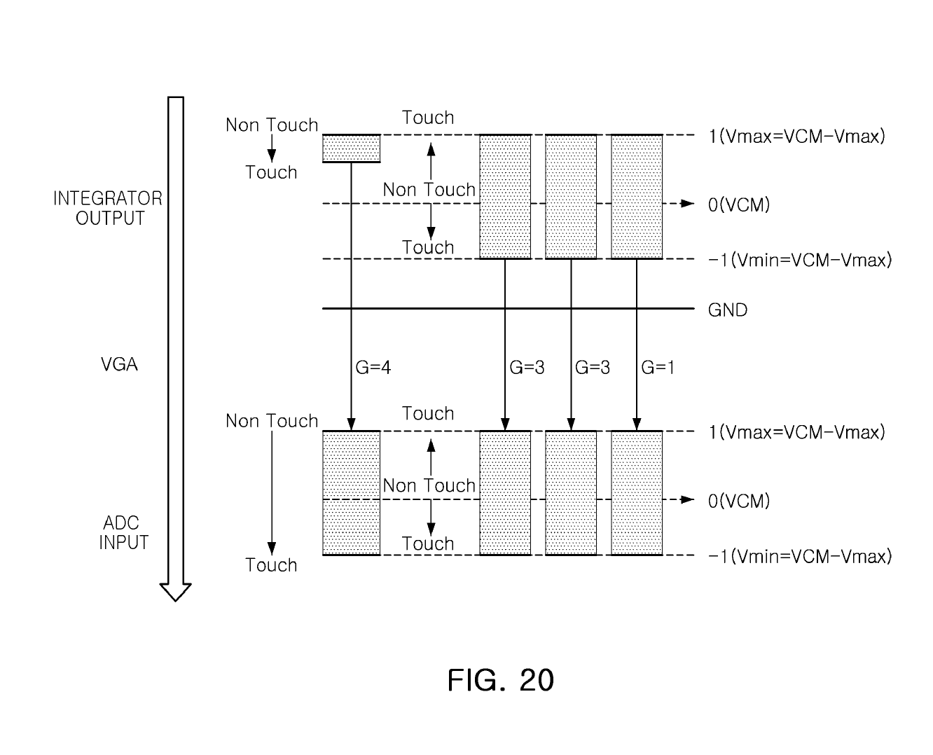

FIG. 20 is a diagram illustrating an ADC input when the variable gain controller 560 according to an exemplary embodiment of the present disclosure is applied.

As described above, referring to FIG. 20, input ranges of ADC input signals are equalized by the variable gain controller (VGA) 560.

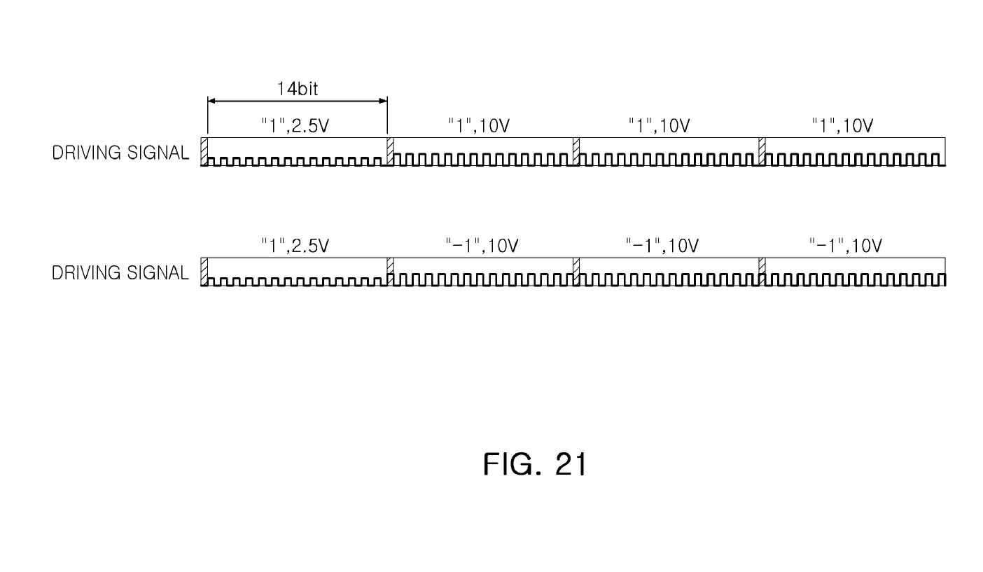

FIG. 21 is a diagram illustrating orthogonalized driving signals according to an exemplary embodiment of the present disclosure.

Referring to FIG. 21, the amplitude of the driving signals in the first column in the modification of the Hadamard code is one-fourth of those in the other columns. For example, the driving signal in the first column may be 2.5V while the driving signals in the second, third and fourth columns may be 10V.

As described above, by driving four driving signals simultaneously, the SNR characteristic may be improved compared to the existing sequential driving manner. The SNR improved value may be approximately \sqrt{¼+1+1+1}=5 dB.

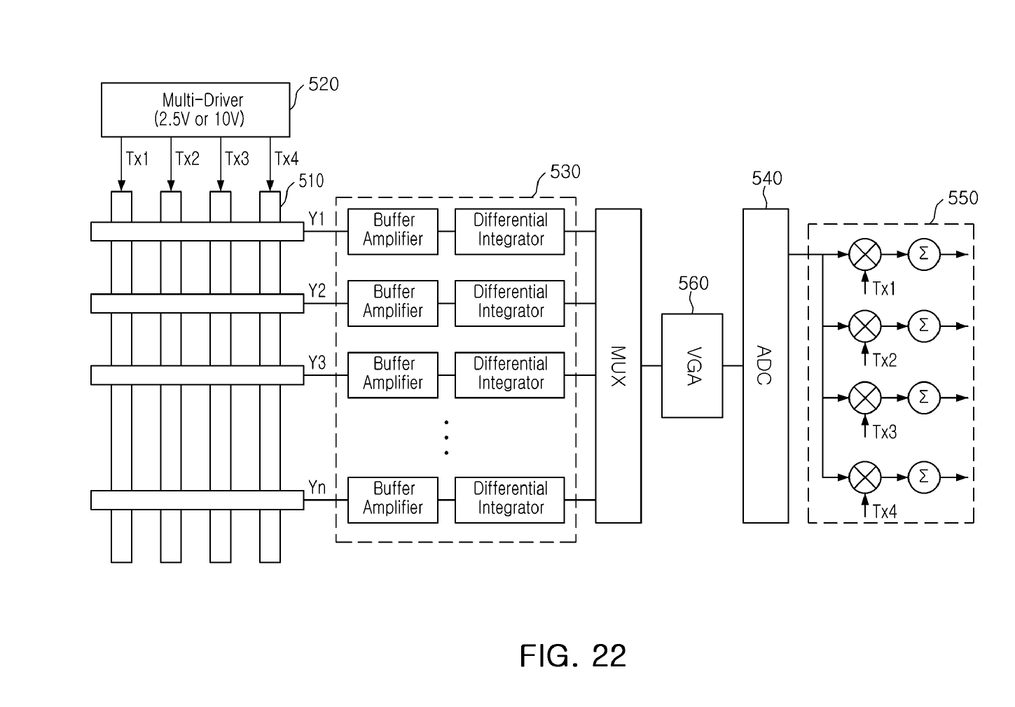

FIG. 22 is a diagram of a capacitance sensing device according to an exemplary embodiment of the present disclosure.

The capacitance sensing device may include a panel unit 510, a driving circuit unit 520, a sensing circuit unit 530, a signal converting unit 540, an operation unit 550 and a variable gain controller 560.

The capacitance sensing device according to an exemplary embodiment of the present disclosure may be driven by orthogonalized driving signals according to an exemplary embodiment of the present disclosure. Here, some of the columns of the driving signals may have smaller amplitudes than the others.

As shown in FIG. 21, the driving circuit unit 520 may apply driving signals with different levels from column to column.

The sensing circuit unit 530 may use sensing circuits described with reference to FIGS. 10 to 12.

The variable gain controller 560 may adjust variations in output in the columns that are input to the ADC 540 to be the same.

The operation unit 550 may detect orthogonal codes to determine whether there is a user's touch.

Although four driving signals are applied in the example for convenience of description, more or less driving signals may be applied.

According to exemplary embodiments of the present disclosure, the SNR characteristic may be improved by virtue of simultaneous driving with minimum increase in the chip area due to the simultaneous driving.

As set forth above, according to exemplary embodiments of the present disclosure, noise influence on a change in capacitance may be minimized.

Further, SNR characteristics may be improved.

Moreover, a plurality of driving signals may be applied without increasing the size of a driving chip.

While exemplary embodiments have been shown and described above, it will be apparent to those skilled in the art that modifications and variations could be made without departing from the spirit and scope of the present disclosure as defined by the appended claims.

What is claimed is:

1. A capacitance sensing device, comprising:
a panel unit including first electrodes arranged in a plurality of columns extending in a first direction, and second electrodes arranged in a plurality of rows extending in a second direction intersecting the first direction;
a driving circuit unit applying a plurality of driving signals to the first electrodes arranged in the plurality of columns, wherein levels of driving signals applied to first electrodes in a part of the columns are different from levels of driving signals applied to first electrodes in the other columns;
a sensing circuit unit sensing a change in capacitance from the second electrodes arranged in the plurality of rows;
a variable gain controller adjusting levels of signals output from the sensing circuit unit to be the same;
an analog-to-digital converter (ADC) converting analog signals output from the variable gain controller into digital signals; and
an operation unit detecting a touch made by a user based on an output from the ADC.

2. The capacitance sensing device of claim 1, wherein the plurality of driving signals is configured based on a modification of the Hadamard code in which levels of signals in a part of columns of the Hadamard Code are changed.

3. A capacitance sensing device, comprising:
a driving circuit unit applying a plurality of driving signals to a first capacitor;
a first integration circuit unit including a second capacitor charged according to a change in capacitance occurring in the first capacitor based on the driving signals to generate a first output voltage; and
a second integration circuit unit including a third capacitor charged according to a change in capacitance occurring in the second capacitor to generate a second output voltage,
wherein levels of driving signals in a part of a plurality of columns among the plurality of driving signals applied to the first capacitor are different from levels of driving signals in the other columns.

4. The capacitance sensing device of claim 3, further comprising a variable gain controller adjusting outputs from the second integration circuit unit corresponding to the plurality of driving signals to be the same.

5. The capacitance sensing device of claim 3, wherein the plurality of driving signals is configured based on a modification of the Hadamard code in which levels of signals in a part of columns of the Hadamard code are changed.

6. A capacitance sensing device, comprising:
a driving circuit unit applying a plurality of driving signals to a first capacitor;
a first integration circuit unit including a second capacitor charged according to a change in capacitance occurring in the first capacitor based on the driving signals to generate a first output voltage; and
a second integration circuit unit including a third capacitor charged according to a change in capacitance occurring in the second capacitor to generate a second output voltage,
wherein the driving signals are orthogonal to one another.

7. The capacitance sensing device of claim 6, wherein each code configuring the driving signals includes an initialization period and an integration period.

8. The capacitance sensing device of claim 7, wherein the first capacitor, the second capacitor and the third capacitor are initialized during the initialization period.

9. The capacitance sensing device of claim 6, wherein the first integration circuit unit includes:
a first switch connected to a ground terminal; and
a second switch connected to an input node of the first integration circuit unit,
wherein the first and second switches are turned on and off periodically, and
a period at which the first and second switches are turned on and off is half a period of the driving signals applied to the first capacitor.

10. The capacitance sensing device of claim 6, wherein the second integration circuit unit include:
a third switch connected to a ground terminal; and
a fourth switch connected to an input node of the second integration circuit unit,
wherein the third and fourth switches are turned on and off periodically, and
a period at which the third and fourth switches are turned on and off is equal to a period of the driving signals applied to the first capacitor.
